(19) United States
(12) Patent Application Publication
(10) Pub. No.: US 2013/0189572 A1
(43) Pub. Date: Jul. 25, 2013

(54) RECHARGEABLE LITHIUM BATTERY

(71) Applicant: Samsung SDI Co., Ltd., Yongin-si (KR)

(72) Inventor: Su-Hee Han, Yongin-si (KR)

(73) Assignee: Samsung SDI Co., Ltd., Yongin-si (KR)

(21) Appl. No.: 13/678,363

(22) Filed: Nov. 15, 2012

(30) Foreign Application Priority Data
Jan. 19, 2012 (KR) 10-2012-0006290

(51) Int. Cl. H01M 10/0525; H01M 4/485; H01M 10/0564

(52) U.S. Cl. CPC H01M 10/0525; H01M 10/0564; H01M 4/485
USPC 429/188

(57) ABSTRACT

In one aspect, a rechargeable lithium battery that includes a negative electrode including a negative active material including lithium titanium-based oxide; a positive electrode including a positive active material being capable of intercalating and deintercalating lithium; and an electrolyte is provided.

### CROSS-REFERENCE TO RELATED APPLICATION

This application claims priority to and the benefit of Korean Patent Application No. 10-2012-0006290 filed on Jan. 19, 2012 in the Korean Intellectual Property Office, the disclosure of which is incorporated in its entirety herein by reference.

### BACKGROUND

1. Field

A rechargeable lithium battery is disclosed.

2. Description of the Related Technology

A rechargeable lithium battery can be used as a power source for a small portable electronic device. It uses an organic electrolyte solution and thereby has twice or more the discharge voltage than that of a conventional battery using an alkali aqueous solution affording a high energy density.

Lithium-transition element composite oxides being capable of intercalating lithium, such as LiCoO₂, LiMn₂O₄, LiNi₁₋ₓCoₓO₂ (0<x<1), and the like, have been developed as positive active materials of a rechargeable lithium battery. Various carbon-based materials such as artificial graphite, natural graphite, and hard carbon, which may intercalate and deintercalate lithium ions have been developed as for negative active materials of a rechargeable lithium battery. Additionally, the use of non-carbon-based negative active materials such as Si have been developed to afford stability and high-capacity.

### SUMMARY

One embodiment of this disclosure provides a rechargeable lithium battery that improves the shortcomings related to IR (AC impedance) increase and the output deterioration caused by using at high temperatures and ensures capacity retention.

According to one embodiment of this disclosure, a rechargeable lithium battery that includes a negative electrode including a negative active material including lithium titanium-based oxide; a positive electrode including a positive active material being capable of intercalating and deintercalating lithium; and an electrolyte is provided.

In certain embodiments, the electrolyte includes about 50 wt % to about 90 wt % of a sum of ethylene carbonate and γ-butyrolactone; about 10 to about 50 wt % of a component selected from the group consisting of propylene carbonate, ethylene acetate, ethylene propionate, and a combination thereof. In certain embodiments, the electrolyte comprises about 20 wt % or about 30 wt % of ethylene carbonate. In certain embodiments, the electrolyte comprises about 20 wt %, about 30 wt %, about 40 wt %, or about 50 wt % of γ-butyrolactone. In certain embodiments, the electrolyte comprises about 20 wt %, about 30 wt %, or about 40 wt % of γ-butyrolactone.

For example, the component selected from the group consisting of propylene carbonate, ethylene acetate, ethylene propionate, and a combination thereof may be a combination of ethylene acetate and ethylene propionate.

In certain embodiments, the electrolyte solution may further include a component selected from the group consisting of dimethyl carbonate, diethyl carbonate, dipropyl carbonate, methylpropyl carbonate, ethylmethyl carbonate, ethylpropyl carbonate, 1,2-butylene carbonate, 2,3-butylene carbonate, 1,2-pentylene carbonate, 2,3-pentylene carbonate, and a combination thereof.

In certain embodiments, the electrolyte may further include a compound represented by the following Chemical Formula 1:

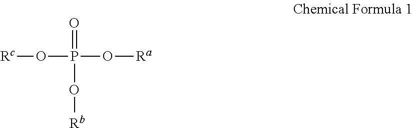

wherein, R^{a}, R^{b}, R^{c} are the same or independently selected from C1 to C4 linear or branched alkyl.

In certain embodiments, the compound may be represented by the following Chemical Formula 2:

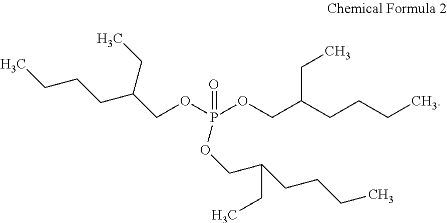 [SMILES: CCCCC(CC)COP(=O)(OCC(CC)CCCC)OCC(CC)CCCC]

In certain embodiments, the electrolyte may include the compound represented by the above Chemical Formula 1 in an amount of about 0.5 wt % to about 5 wt %.

In certain embodiments, the lithium titanium-based oxide may be represented by the following Chemical Formula 3:

Li_{4-x-y}M_{y}Ti_{5+x-z}M′_{z}O₁₂ Chemical Formula 3

In Chemical Formula 1,

x may have a value ranging from 0 to 1, y may have a value ranging from 0 to 1, z may have a value ranging from 0 to 1,

In certain embodiments, M may be an element selected from the group consisting of La, Tb, Gd, Ce, Pr, Nd, Sm, Ba, Sr, Ca, and Mg, or a combination thereof, and

In certain embodiments, M′ may be selected from the group consisting of V, Cr, Nb, Fe, Ni, Co, Mn, W, Al, Ga, Cu, Mo, and P (phosphorus), or a combination thereof.

In certain embodiments, the lithium titanium-based oxide may be at least one selected from the group consisting of Li_{3.9}Mg_{0.1}Ti₅O₁₂, Li₄Ti_{4.8}V_{0.2}O₁₂, Li₄Ti_{4.8}Nb_{0.2}O₁₂, Li₄Ti_{4.8}Mo_{0.2}O₁₂, and Li₄Ti_{4.8}P_{0.2}O₁₂.

In certain embodiments, the lithium titanium-based oxide may be represented by the following Chemical Formula 4:

Li₄₋ₓTi₅₊ₓO₁₂. Chemical Formula 4

In Chemical Formula 4, x may have a value ranging from 0 to 1.

In certain embodiments, the lithium titanium-based oxide may be Li₄Ti₅O₁₂.

In certain embodiments, the electrolyte may further include at least one lithium salt selected from the group consisting of LiPF₆, LiBF₄, LiSbF₆, LiAsF₆, LiC₄F₉SO₃, LiClO₄, LiAlO₂, LiAlCl₄, LiN(SO₂CₓF₂ₓ₊₁)(SO₂C_{y}F_{2y+1}) (wherein, x and y are natural numbers of 1 to 20, respectively), LiCl, LiI, LiB(C₂O₄)₂ (lithium bis(oxalato) borate; LiBOB), or a combination thereof.

In certain embodiments, the lithium salt may be used in a concentration ranging from about 0.1 M to about 2.0 M.

In certain embodiments, the positive active material may be selected from the group consisting of LiₐA_{1-b}R_{b}L₂ (0.90≦a≦1.8 and 0≦b≦0.5);
LiₐE_{1-b}R_{b}O_{2-c}L_{c} (0.90≦a≦1.8, 0≦b≦0.5 and 0≦c≦0.05);
LiE_{2-b}R_{b}O_{4-c}L_{c} (0≦b≦0.5, 0≦c≦0.05);
LiₐNi_{1-b-c}Co_{b}R_{c}L_{α} (0.90≦a≦1.8, 0≦b≦0.5, 0≦c≦0.05 and 0<α≦2);
LiₐNi_{1-b-c}Co_{b}R_{c}O_{2-α}Z_{α} (0.90≦a≦1.8, 0≦b<0.5, 0≦c≦0.05 and 0<α<2);
LiₐNi_{1-b-c}Co_{b}R_{c}O_{2-α}Z₂ (0.90≦a≦1.8, 0≦b<0.5, 0≦c≦0.05 and 0<α<2);
LiₐNi_{1-b-c}Mn_{b}R_{c}L_{α} (0.90≦a≦1.8, 0≦b≦0.5, 0≦c≦0.05 and 0<α≦2);
LiₐNi_{1-b-c}Mn_{b}R_{c}O_{2-α}Z_{α} (0.90≦a ≦1.8, 0≦b ≦0.5, 0≦c≦0.05 and 0<α<2);
LiₐNi_{1-b-c}Mn_{b}R_{c}O_{2-α}Z₂ (0.90≦a≦1.8, 0≦b≦0.5, 0≦c≦0.05 and 0<α<2);
LiₐNi_{b}E_{c}G_{d}O₂ (0.90≦a≦1.8, 0≦b≦0.9, 0≦c≦0.5 and 0.001≦d≦0.1);
LiₐNi_{b}Co_{c}Mn_{d}GₑO₂ (0.90≦a≦1.8, 0≦b≦0.9, 0≦c≦0.5, 0≦d≦0.5 and 0.001≦e≦0.1);
LiₐNiG_{b}O₂ (0.90≦a≦1.8 and 0.001≦b≦0.1);
LiₐCoG_{b}O₂ (0.90≦a≦1.8 and 0.001≦b≦0.1);
LiₐMnG_{b}O₂ (0.90≦a≦1.8 and 0.001≦b≦0.1);
LiₐMn₂G_{b}O₄ (0.90≦a≦1.8 and 0.001≦b≦0.1);
QO₂; QS₂; LiQS₂; V₂O₅; LiV₂O₅; LiTO₂; LiNiVO₄; Li_{(3-f)}J₂(PO₄)₃ (0≦f≦2);
Li_{(3-f)}Fe₂(PO₄)₃ (0≦f≦2); LiFePO₄, or a combination thereof,

A may be Ni, Co, Mn, or a combination thereof; R is Al, Ni, Co, Mn, Cr, Fe, Mg, Sr, V, a rare earth element, or a combination thereof; L may be O (oxygen), F (fluorine), S (sulfur), P (phosphorus), or a combination thereof; E may be Co, Mn, or a combination thereof; Z is F (fluorine), S (sulfur), P (phosphorus), or a combination thereof; G may be Al, Cr, Mn, Fe, Mg, La, Ce, Sr, V, or a combination thereof; Q may be Ti, Mo, Mn, or a combination thereof; T may be Cr, V, Fe, Sc, Y, or a combination thereof; and J may be V, Cr, Mn, Co, Ni, Cu, or a combination thereof. In certain embodiments, the positive active material may be LiₐA_{1-b}R_{b}L₂ (0.90≦a≦1.8 and 0≦b ≦0.5); A may be Ni, Co, Mn; R may be Al, Ni, Co, Mn, Cr, Fe, Mg, Sr, V; and L may be O (oxygen), F (fluorine), S (sulfur), P (phosphorus). In certain embodiments, the positive active material may be LiₐA_{1-b}R_{b}L₂ (0.90≦a≦1.8 and 0≦b≦0.5); A may be Co; and L may be O (oxygen). In certain embodiments, the positive active material may be LiCoO₂.

In certain embodiments, the rechargeable lithium battery affords improved capacity retention by improving the shortcomings related to the IR (potential difference) increase and the output power deterioration caused by using at a high temperature atmosphere.

### BRIEF DESCRIPTION OF THE DRAWING

FIG. 1 is a schematic view showing a rechargeable lithium battery according to an aspect of the present embodiments.

### DETAILED DESCRIPTION

Exemplary embodiments of this disclosure will hereinafter be described in detail. However, these embodiments are exemplary, and this disclosure is not limited thereto.

In certain embodiments, the rechargeable lithium battery includes a negative electrode including a negative active material including lithium titanium-based oxide; a positive electrode including a positive active material being capable of intercalating and deintercalating lithium; and an electrolyte.

In certain embodiments, the electrolyte includes ethylene carbonate and γ-butyrolactone and further includes a component selected from the group consisting of propylene carbonate, ethylene acetate, ethylene propionate, and a combination thereof. For example, the component may be a combination of ethylene acetate and ethylene propionate. In certain embodiments, the electrolyte includes ethylene carbonate, γ-butyrolactone, ethylene acetate, and ethylene propionate.

In certain embodiments, the sum of ethylene carbonate and γ-butyrolactone may have a value ranging from about 50 wt % to about 90 wt %; and the amount of a component selected from the group consisting of propylene carbonate, ethylene acetate, ethylene propionate, and a combination thereof may have a value ranging from about 10 to about 50 wt % in the electrolyte. In certain embodiments, the electrolyte comprises about 20 wt % or about 30 wt % of ethylene carbonate. In certain embodiments, the electrolyte comprises about 20 wt %, about 30 wt %, about 40 wt %, or about 50 wt % of γ-butyrolactone. In certain embodiments, the electrolyte comprises about 20 wt %, about 30 wt %, or about 40 wt % of γ-butyrolactone.

In certain embodiments, the electrolyte may control the viscosity of electrolyte by mixing ethylene carbonate and γ-butyrolactone with a low viscosity solvent of ethylene acetate, ethylene propionate or with a high conductive solvent of propylene carbonate. For example, the electrolyte may have a viscosity of about 2 cp to about 7 cp at room temperature. In certain embodiments, the composition of electrolyte may improve the wettability of active material and separator and, resultantly, improve the problems of the thickness increase during storing at a high temperature.

One of several problems caused when the rechargeable lithium battery is allowed to stand at a high temperature for a long time is thickness increase according to storing at a high temperature. The thickness increase causes the exterior deformation so as to generate a structural problem and to deteriorate the close contacting property between electrodes due to the thickness increase, thereby, IR (potential difference) is increased and the output power is deteriorated, and the capacity is deteriorated. In contrast, the rechargeable lithium battery including the composition of electrolyte disclosed herein may provide excellent effects with respect to preventing the output power deterioration (IR increase) due to using at the high temperature atmosphere and of ensuring the capacity retention. This effect may be particularly pronounced for a rechargeable lithium battery including a negative active material of lithium titanium-based oxide which may have more serious problems of increasing thickness during storage at a high temperature in comparison to a rechargeable lithium battery including another negative active material.

In certain embodiments, the electrolyte may further include a solvent selected from the group consisting of dimethyl carbonate, diethyl carbonate, dipropyl carbonate, methylpropyl carbonate, ethylmethyl carbonate, ethylpropyl carbonate, 1,2-butylene carbonate, 2,3-butylene carbonate, 1,2-pentylene carbonate, 2,3-pentylene carbonate, and a combination thereof.

In certain embodiments, the electrolyte may further include a solvent including an ester-moiety, ether-moiety, ketone-moiety, alcohol-moiety, or aprotic solvent, in addition to a solvent including a carbonate-moiety. In certain embodiments, the solvent including an ester-moiety may include methyl acetate, ethyl acetate, n-propyl acetate, dimethylacetate, methylpropionate, ethylpropionate, γ-butyrolactone, decanolide, valerolactone, mevalonolactone, caprolactone, and the like, the solvent including an ether-moiety may include dibutyl ether, tetraglyme, diglyme, dimethoxyethane, 2-methyltetrahydrofuran, tetrahydrofuran, and the like, and the solvent including a ketone-moiety may include cyclohexanone, and the like. In certain embodiments, the solvent including an alcohol-moiety may include ethanol, isopropyl alcohol, and the like, and the aprotic solvent may include nitriles such as R—CN (wherein R is a C2 to C20 linear, branched or a cyclic hydrocarbon group, and may include a double bond, an aromatic ring, or an ether bond), amides such as dimethylformamide, dimethylacetamide, dioxolanes such as 1,3-dioxolane, sulfolanes, and the like. When the solvent may be further used with the solvent including a carbonate-moiety, their mixing ratio may be controlled in accordance with a desirable battery performance as understood by a person skilled in the related art.

In certain embodiments, the electrolyte may further include a solvent including an aromatic hydrocarbon-moiety. In certain embodiments, the solvent including a carbonate-moiety and the solvent including an aromatic hydrocarbon-moiety may be mixed in a volume ratio of about 1:1 to about 30:1.

In certain embodiments, the aromatic hydrocarbon-based organic solvent may be an aromatic hydrocarbon-based compound represented by the following Chemical Formula 5:

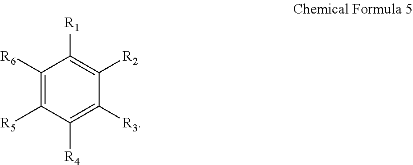

In Chemical Formula 5, R₁ to R₆ are each independently hydrogen, a halogen, a C1 to C10 alkyl group, a C1 to C10 haloalkyl group, or a combination thereof.

In certain embodiments, the solvent including an aromatic hydrocarbon-moiety may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In certain embodiments, the electrolyte may further include a compound represented by the Chemical Formula 1 as an additive:

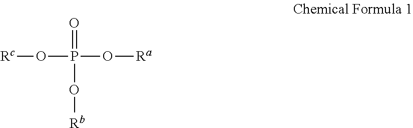

wherein, R^{a}, R^{b}, R^{c} are the same or independently selected from C1 to C4 linear or branched alkyl.

In certain embodiments, the compound may be tris(2-ethylhexyl)phosphate represented by the following Chemical Formula 2:

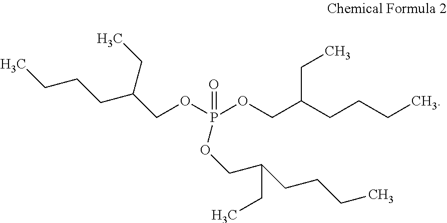 [SMILES: CCCCC(CC)COP(=O)(OCC(CC)CCCC)OCC(CC)CCCC]

When the electrolyte further include the compound represented by Chemical Formula 1, the miscibility of γ-butyrolactone may be further improved, and resultantly, it is effective for improving the wettability of active material and a separator and suppressing the gas generation.

In certain embodiments, the electrolyte may include the compound represented by Chemical Formula 1 in about 0.5 to about 5 wt %.

In certain embodiments, the electrolyte further includes a lithium salt together with the non-aqueous organic solvent.

In certain embodiments, the lithium salt may be dissolved in an organic solvent and supplies lithium ions in a battery, operates a basic operation of the rechargeable lithium battery, and improves lithium ion transportation between positive and negative electrodes therein. Examples of the lithium salt include, but are not limited to, LiPF₆, LiBF₄, LiSbF₆, LiAsF₆, LiC₄F₉SO₃, LiClO₄, LiAlO₂, LiAlCl₄, LiN(SO₂CₓF₂ₓ₊₁)(SO₂C_{y}F_{2y+1}) (wherein x and y are natural numbers of 1 to 20, respectively), LiCl, LiI, LiB(C₂O₄)₂ (lithium bis(oxalato) borate, LiBOB), or a combination thereof, as a supporting electrolytic salt. In certain embodiments, the lithium salt may be used in a concentration ranging from about 0.1 M to about 2.0 M. In certain embodiments, an electrolyte may have excellent performance and lithium ion mobility due to optimal electrolyte conductivity and viscosity when the lithium salt is included in a concentration ranging from about 0.1 M to about 2.0 M.

In certain embodiments, the electrolyte may be a gel polymer electrolyte. Such a gel polymer electrolyte may be obtained from polymerization within a battery. The gel polymer electrolyte may be prepared by adding a polymer-forming monomer and a polymerization initiator to an electrolyte including an organic solvent, an additive having a borate structure, and a lithium salt to prepare an electrolyte precursor solution, fabricating a battery using the solution, and allowing the battery to stand at a temperature at which polymerization starts for a predetermined number of hours. This gel polymer electrolyte refers to a chemical gel. The polymer-forming monomer may include acrylate, methacrylate, polyethyleneoxide (PEO), polypropyleneoxide (PPO), polyacrylonitrile (PAN), polyvinylidenefluoride (PVDF), polymethacrylate (PMA), polymethylmethacrylate (PMMA), diethylene glycol(DEG), ethylene glycol(EG), adipic acid-based monomer, trimethylolpropane, or a polymer thereof. In addition, the monomer may include poly(ester)(meth)acrylate prepared by substituting a part or all of three-OH group of polyester)polyol with (meth)acrylic acid ester and substituting a group with no radical reactivity for the unsubstituted non-reacted —OH groups.

Examples of the polymer in the gel polymer electrolyte presented within the battery after forming the chemical gel, may include polyethyleneglycoldimethacrylate (PEGDMA), polyethyleneglycolacrylate, and the like. The examples of the gel polymer electrolyte are prepared by polymerizing a polymer through heating and appropriately selecting kinds and concentrations of the monomer, and controlling a temperature and time for polymerizing.

In order to prepare the gel polymer electrolyte from the aforementioned monomers, a polymerization initiator may be either organic peroxide or an azo-based compound or a mixture thereof.

In certain embodiments, the organic peroxide may include diacyl peroxides such as diacetyl peroxide, dibenzoyl peroxide, dilauroyl peroxide, bis-3,5,5-trimethyl hexanoyl peroxide, and the like; peroxy dicarbonates such as di(4-t-butylcyclohexyl) peroxy dicarbonate, di-2-ethylhexyl peroxy dicarbonate, di-isopropyl peroxydicarbonate, di-3-methoxybutyl peroxy dicarbonate, t-butyl peroxy-isopropyl carbonate, t-butylperoxy-2-ethylhexyl carbonate, 1,6-bis(t-butyl peroxycarbonyloxy)hexane, diethyleneglycol-bis(t-butyl peroxy carbonate), and the like; and peroxyesters such as t-butyl peroxy pivalate, t-amyl peroxy pivalate, t-butyl peroxy-2-ethyl-hexanoate, t-hexyl peroxy pivalate, t-butyl peroxy neoheptanoate, t-hexyl peroxy pivalate, 1,1,3,3-tetramethylbutyl peroxy neodecarbonate, 1,1,3,3-tetramethylbutyl 2-ethylhexanoate, t-amylperoxy 2-ethylhexanoate, t-butyl peroxy isobutyrate, t-amylperoxy 3,5,5-trimethyl hexanoyl, t-butyl peroxy 3,5,5-trimethylhexanoate, t-butyl peroxy acetate, t-butyl peroxy benzoate, di-butylperoxy trimethyl adipate, and the like.

In certain embodiments, the azo-based compound may be 2,2′-azo-bis(isobutyronitrile), 2,2′-azo-bis(2,4-dimethylvaleronitrile), or 1,1′-azo-bis(cyanocyclo-hexane).

The lithium titanium-based oxide has characteristics of charge at high rates, long cycle-life, and high stability, so as to be usefully applied to a negative electrode for a medium or large-sized rechargeable lithium battery.

In certain embodiments, the lithium titanium-based oxide may be represented by Chemical Formula 3:

Li_{4-x-y}M_{y}Ti_{5+x-z}M′_{z}O₁₂. Chemical Formula 3

In Chemical Formula 3, x may have a value ranging from 0 to 1, y may have a value in the range from 0 to 1, z may have a value ranging from 0 to 1, M may be an element selected from the group consisting of from La, Tb, Gd, Ce, Pr, Nd, Sm, Ba, Sr, Ca, and Mg, or a combination thereof, M′ may be selected from the group consisting of V, Cr, Nb, Fe, Ni, Co, Mn, W, Al, Ga, Cu, Mo, and P (phosphorus), or a combination thereof.

In certain embodiments, the lithium titanium-based oxide of the above Chemical Formula 3 may include Li_{3.9}Mg_{0.1}Ti₅O₁₂, Li₄Ti_{4.8}V_{0.2}O₁₂, Li₄Ti_{4.8}Nb_{0.2}O₁₂, Li₄Ti_{4.8}Mo_{0.2}O₁₂, Li₄Ti_{4.8}P_{0.2}O₁₂, and the like. Since the lithium titanium-based oxide has a stable spinel structure, the spinel structure does not change the X-ray diffraction (XRD) peak using Cu Kα ray even though a small amount of lithium or titanium is substituted with other transient metal in the lithium titanium-based oxide.

In certain embodiments, the lithium titanium-based oxide may be represented by the following Chemical Formula 4:

Li₄₋ₓTi₅₊ₓO₁₂ Chemical Formula 4

wherein, in the above Chemical Formula 4, x may be 0 to 1.

In certain embodiments, the lithium titanium-based oxide may be Li₄Ti₅O₁₂.

In certain embodiments, the rechargeable lithium battery may be classified as lithium ion batteries, lithium ion polymer batteries, and lithium polymer batteries according to the presence of a separator and the kind of electrolyte used therein. The rechargeable lithium batteries may have a variety of shapes and sizes, and include cylindrical, prismatic, coin, or pouch-type batteries, and may be thin film batteries, or may be rather bulky in size. Structures and fabricating methods for the batteries pertaining to the present embodiments are well known in the art.

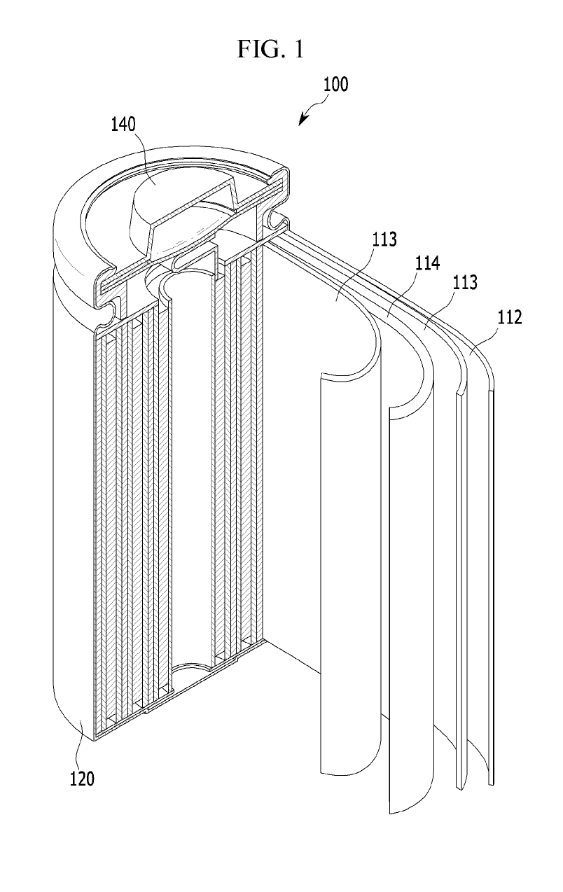

FIG. 1 is an exploded perspective view of a lithium secondary battery according to an aspect of the present embodiments. Referring to FIG. 1, the rechargeable lithium battery 100 is a cylindrical battery that includes a negative electrode 112, a positive electrode 114, and a separator 113 disposed between the negative electrode 112 and positive electrode 114, electrolyte (not shown) impregnated in the negative electrode 112, positive electrode 114, and separator 113, a battery case 120, and a sealing member 140 sealing the battery case 120. The rechargeable lithium battery 100 may be fabricated by sequentially laminating a negative electrode 112, and a separator 113, and a positive electrode 114, spirally winding them, and housing the spiral-wound product in a battery case 120.

In certain embodiments, the negative electrode includes a current collector and a negative active material layer formed over the current collector, and the negative active material layer includes a negative active material.

In certain embodiments, the negative active material may be the lithium titanium-based oxide as described herein. In certain embodiments, the negative active material layer may include a binder, and optionally may further include a conductive material.

The binder improves binding properties of the negative active material particles to each other and to a current collector. Examples of the binder include, but are not limited to, at least one component selected from the group consisting of polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon and the like.

In certain embodiments, the negative active material layer may include a conductive material. Any electrically conductive material may be used as a conductive material that does not cause a chemical change. Examples of the conductive material include, but are not limited to, a carbon-based material such as natural graphite, artificial graphite, carbon black, acetylene black, ketjen black, a carbon fiber, and the like; a metal-based material such as a metal powder or a metal fiber including copper, nickel, aluminum, silver, and the like; a conductive polymer such as a polyphenylene derivative; or a mixture thereof.

In certain embodiments, the current collector may be a copper foil, a nickel foil, a stainless steel foil, a titanium foil, a nickel foam, a copper foam, a polymer substrate coated with a conductive metal, or combinations thereof.

In certain embodiments, the positive electrode includes a current collector and a positive active material layer disposed on the current collector.

In certain embodiments, the positive active material includes lithiated intercalation compounds that reversibly intercalate and deintercalate lithium ions. In certain embodiments, the positive active material may include a composite oxide including cobalt, manganese, nickel, or a combination thereof, as well as lithium. In particular, the following compounds may be used:

LiₐA_{1-b}R_{b}L₂ (0.90≦a≦1.8 and 0≦b≦0.5);
LiₐE_{1-b}R_{b}O_{2-c}L_{c} (0.90≦a≦1.8, 0≦b≦0.5 and 0≦c≦0.05);
LiE_{2-b}R_{b}O_{4-c}L_{c} (0≦b≦0.5, 0≦c≦0.05);
LiₐNi_{1-b-c}Co_{b}R_{c}L_{α} (0.90≦a≦1.8, 0≦b≦0.5, 0≦c≦0.05 and 0<α≦2);
LiₐNi_{1-b-c}Co_{b}R_{c}O_{2-α}Z_{α} (0.90≦a≦1.8, 0≦b<0.5, 0≦c≦0.05 and 0<α<2);
LiₐNi_{1-b-c}Co_{b}R_{c}O_{2-α}Z₂ (0.90≦a≦1.8, 0≦b<0.5, 0≦c≦0.05 and 0<α<2);
LiₐNi_{1-b-c}Mn_{b}R_{c}L_{α} (0.90≦a≦1.8, 0≦b≦0.5, 0≦c≦0.05 and 0<α≦2);
LiₐNi_{1-b-c}Mn_{b}R_{c}O_{2-α}Z_{α} (0.90≦a≦1.8, 0≦b≦0.5, 0≦c≦0.05 and 0<α<2);
LiₐNi_{1-b-c}Mn_{b}R_{c}O_{2-α}Z₂ (0.90≦a≦1.8, 0≦b≦0.5, 0≦c≦0.05 and 0<α<2);
LiₐNi_{b}E_{c}G_{d}O₂ (0.90≦a≦1.8, 0≦b≦0.9, 0≦c≦0.5 and 0.001≦d≦0.1);
LiₐNi_{b}Co_{c}Mn_{d}GₑO₂ (0.90≦a≦1.8, 0≦b≦0.9, 0≦c≦0.5, 0≦d≦0.5 and 0.001≦e≦0.1);
LiₐNiG_{b}O₂ (0.90≦a≦1.8 and 0.001≦b≦0.1);
LiₐCoG_{b}O₂ (0.90≦a≦1.8 and 0.001≦b≦0.1);
LiₐMnG_{b}O₂ (0.90≦a≦1.8 and 0.001≦b≦0.1);
LiₐMn₂G_{b}O₄ (0.90≦a≦1.8 and 0.001≦b≦0.1);
QO₂; QS₂; LiQS₂; V₂O₅; LiV₂O₅; LiTO₂; LiNiVO₄;
Li_{(3-f)}Fe₂(PO₄)₃ (0≦f≦2); LiFePO₄.

In the preceding Chemical Formulae, A is Ni, Co, Mn, or a combination thereof; R is Al, Ni, Co, Mn, Cr, Fe, Mg, Sr, V, a rare earth element, or a combination thereof; L is O (oxygen), F (fluorine), S (sulfur), P (phosphorus), or a combination thereof; E is Co, Mn, or a combination thereof; Z is F (fluorine), S (sulfur), P (phosphorus), or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof. In certain embodiments, the positive active material may be LiₐA_{1-b}R_{b}L₂ (0.90≦a≦1.8 and 0≦b≦0.5); A may be Ni, Co, Mn; R may be Al, Ni, Co, Mn, Cr, Fe, Mg, Sr, V; and L may be O (oxygen), F (fluorine), S (sulfur), P (phosphorus). In certain embodiments, the positive active material may be LiₐA_{1-b}R_{b}L₂ (0.90≦a≦1.8 and 0≦b≦0.5); A may be Co; and L may be O (oxygen). In certain embodiments, the positive active material may be LiCoO₂.

In certain embodiments, the compound can have a coating layer on the surface, or may be mixed with a compound having a coating layer. In certain embodiments, the coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. In certain embodiments, the compounds for a coating layer can be amorphous or crystalline. In certain embodiments, the coating element for a coating layer may include Mg, Al, Co, K, Na, Ca, Si, Ti, V, Sn, Ge, Ga, B, As, Zr, or a mixture thereof. In certain embodiments, the coating layer can be formed in a method having no negative influence on properties of a positive active material by including these elements in the compound. For example, the method may include any coating method such as spray coating, dipping, and the like known to those of skill in the art.

In certain embodiments, the positive active material layer may include a binder and a conductive material.

The binder improves binding properties of the positive active material particles to one another and also, with a current collector. Examples of the binder include, but are not limited to, polyvinylalcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

In certain embodiments, the negative active material layer may include a conductive material. Any electrically conductive material may be used as a conductive material that does not cause a chemical change. Examples of the conductive material include, but are not limited to, natural graphite, artificial graphite, carbon black, acetylene black, ketjen black, a carbon fiber, a metal powder, a metal fiber of copper, nickel, aluminum, silver, and the like, a conductive material such as a polyphenylene derivative.

In certain embodiments, the current collector may be Al, but is not limited thereto.

In certain embodiments, the negative and positive electrodes may be fabricated by a method including mixing the active material, a conductive material, and a binder into an active material composition, and coating the composition on a current collector, respectively. Methods of manufacturing an electrode are well known to those of skill in the art, and thus is not described in detail in the present specification. In certain embodiments, the solvent includes N-methylpyrrolidone and the like, but is not limited thereto.

In certain embodiments, the rechargeable lithium battery may further include a separator between the negative electrode and the positive electrode, as needed. In certain embodiments, the separator may include polyethylene, polypropylene, polyvinylidene fluoride or multi-layers thereof such as a polyethylene/polypropylene double-layered separator, a polyethylene/polypropylene/polyethylene triple-layered separator, a polypropylene/polyethylene/polypropylene triple-layered separator, and the like.

Exemplary embodiments are described in more detail according to Examples and Comparative Examples below. The following examples are for illustrative purposes only and are not intended to limit the scope of the one or more embodiments.

### EXAMPLE

### Examples 1 to 21

Electrodes were fabricated using a positive active material of a lithium cobalt-based oxide (LiCoO₂) and a negative active material of Li₄T₅O₁₂ (LTO). A film separator of polyethylene (PE) material was inserted between the provided electrodes and injected with an electrolyte to provide a rechargeable lithium battery cell having a capacity of 330 mAh. The electrolyte was prepared by adding a monomer and a polymerization initiator to a mixture of 1.0 M LiPF₆ and a solvent. The solvent composition was shown in the following Table 1. As the monomer, a polyester polyol monomer obtained from the condensation of ethylene glycol, diethylene glycol, trimethyolpropane and adipic acid, was used and as the initiator, 2,2-azo-bis(2,4-dimethylvaleronitrile) was used. The amount of the monomer was about 10 wt % based on the weight of the mixture and the amount of the initiator was about 0.1 wt % based on the weight of the mixture.

The rechargeable lithium battery cell was allowed to stand at 45° C. for 1 hour or more to occur a polymerization. As a result, a rechargeable lithium battery cell including a gel polymer electrolyte was fabricated.

The components for the composition of electrolytes were as follows:
EC: ethylene carbonate
GBR: γ-butyrolactone
PC: propylene carbonate
EA: ethylene acetate
EP: ethylene propionate
TOP: compound represented by the following Chemical Formula 2:

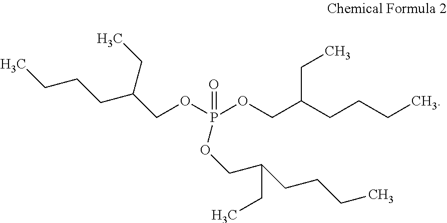 [SMILES: CCCCC(CC)COP(=O)(OCC(CC)CCCC)OCC(CC)CCCC]

### Comparative Examples 1 to 5

A rechargeable lithium battery cell was fabricated in accordance with the same procedure as in Examples, except that including the negative active material of graphite and the electrolyte having the composition shown in the following Table 2.

### Comparative Examples 6 to 12

A rechargeable lithium battery cell was fabricated in accordance with the same procedure as in Examples, except for including the electrolyte having the composition shown in the following Table 2.

### Experimental Example 1: Evaluation of high temperature storage thickness increase rate

Each lithium battery cell obtained from Examples 1 to 21 and Comparative Examples 1 to 12 was stored at SOC (state of charge: charging state) of 0% and at a temperature of 60° C. for 30 days and measured for the thickness to calculate thickness increase rates. The results are shown in the following Table 1 and Table 2. The thickness of battery cell was determined by measuring the front part and the rear part of battery with vernier calipers.

### Experimental Example 2: Evaluation of temperature storage IR increase rate

Each lithium battery cell obtained from Examples 1 to 21 and Comparative Examples 1 to 12 was stored at SOC of 0% and at a temperature of 60° C. for 30 days and measured for IR (potential difference) increase rate. The results are shown in the following Table 1 and Table 2.

### Experimental Example 3: Evaluation of cycle-life characteristics

Each lithium ion battery cell obtained from Examples 1 to 21 and Comparative Examples 1 to 12 charged and discharged at 25° C. and at 1 C for 100 times, and the percent value to the initial discharge capacity was calculated. The results are shown in the following Table 1 and Table 2.

### Experimental Example 4: Evaluation of Formation capacity

Each lithium battery cell obtained from Examples 1 to 21 and Comparative Examples 1 to 12 was formation-charged and -discharged, and then it was charged and discharged. The discharge capacity is shown in the following Table 1 and Table 2.

TABLE 1

| | | | | | | | | | | cycle-life | |
|---|---|---|---|---|---|---|---|---|---|---|---|
| | Negative | | | | | | | Thickness | IR | capacity % | Formation |
| | active | Electrolytes composition (wt %) | | | | | | increase | increase | (after 100^{th} | capacity |
| | material | EC | GBL | PC | EA | EP | TOP | rate | rate | cycle) | (mAh) |
| Example 1 | LTO | 30 | 60 | 10 | — | — | — | 1% | 17% | 88% | 309 |
| Example 2 | LTO | 30 | 50 | 20 | — | | — | 7% | 22% | 87% | 308 |
| Example 3 | LTO | 30 | 40 | 30 | — | — | — | 6% | 21% | 95% | 302 |
| Example 4 | LTO | 30 | 20 | 50 | — | — | — | 1% | 15% | 92% | 302 |
| Example 5 | LTO | 30 | 60 | — | 10 | — | — | 4% | 16% | 84% | 325 |
| Example 6 | LTO | 30 | 40 | — | 30 | — | — | 6% | 17% | 91% | 331 |
| Example 7 | LTO | 30 | 30 | — | 40 | — | — | 8% | 15% | 94% | 334 |
| Example 8 | LTO | 30 | 20 | — | 50 | — | — | 12% | 19% | 96% | 332 |
| Example 9 | LTO | 30 | 60 | — | — | 10 | — | 5% | 13% | 87% | 329 |
| Example 10 | LTO | 30 | 40 | — | — | 30 | — | 4% | 15% | 89% | 341 |
| Example 11 | LTO | 30 | 30 | — | — | 40 | — | 3% | 16% | 96% | 343 |
| Example 12 | LTO | 30 | 20 | — | — | 50 | — | 5% | 15% | 97% | 346 |
| Example 13 | LTO | 20 | 30 | — | 20 | 30 | — | 9% | 21% | 96% | 342 |
| Example 14 | LTO | 30 | 50 | — | 10 | 10 | — | 6% | 22% | 91% | 336 |
| Example 15 | LTO | 20 | 50 | 20 | 10 | — | — | 5% | 18% | 85% | 338 |
| Example 16 | LTO | 20 | 50 | 20 | — | 10 | — | 3% | 9% | 87% | 332 |
| Example 17 | LTO | 30 | 40 | 10 | 10 | 10 | — | 7% | 21% | 90% | 336 |
| Example 18 | LTO | 20 | 30 | 10 | 20 | 20 | — | 11% | 19% | 93% | 337 |
| Example 19 | LTO | 30 | 60 | 10 | — | — | 0.5 | 1% | 15% | 90% | 321 |
| Example 20 | LTO | 30 | 60 | 10 | — | — | 3 | 5% | 13% | 89% | 325 |
| Example 21 | LTO | 30 | 60 | 10 | — | — | 5 | 8% | 12% | 85% | 327 |

TABLE 2

| | | | | | | | | | | Cycle-life | |
|---|---|---|---|---|---|---|---|---|---|---|---|
| | Negative | | | | | | | Thickness | IR | capacity % | Formation |
| | active | Electrolyte | | | | | | increase | increase | (after 100^{th} | capacity |
| | material | EC | GBL | PC | EA | EP | TOP | rate | rate | cycle) | (mAh) |
| Comparative | Gr | 30 | 70 | — | — | — | — | 8% | 34% | 74% | 286 |
| Example 1 | | | | | | | | | | | |
| Comparative | Gr | 30 | 40 | 30 | — | — | — | 17% | 25% | 81% | 278 |
| Example 2 | | | | | | | | | | | |
| Comparative | Gr | 30 | 40 | — | 30 | — | — | 15% | 36% | 87% | 302 |
| Example 3 | | | | | | | | | | | |
| Comparative | Gr | 30 | 40 | — | — | 30 | — | 17% | 21% | 90% | 304 |
| Example 4 | | | | | | | | | | | |
| Comparative | Gr | 20 | 40 | 20 | 10 | 10 | — | 12% | 27% | 85% | 295 |
| Example 5 | | | | | | | | | | | |
| Comparative | LTO | 30 | 70 | — | — | — | — | 3% | 30% | 71% | 304 |
| Example 6 | | | | | | | | | | | |
| Comparative | LTO | 30 | 65 | 5 | — | — | — | 4% | 32% | 75% | 305 |
| Example 7 | | | | | | | | | | | |
| Comparative | LTO | 25 | 70 | — | 5 | — | — | 4% | 38% | 73% | 312 |
| Example 8 | | | | | | | | | | | |
| Comparative | LTO | 20 | 20 | 60 | — | — | — | 7% | 34% | 73% | 335 |
| Example 9 | | | | | | | | | | | |
| Comparative | LTO | 20 | 20 | — | 60 | — | — | 16% | 41% | 78% | 335 |
| Example 10 | | | | | | | | | | | |
| Comparative | LTO | 20 | 20 | — | — | 60 | — | 18% | 38% | 81% | 337 |
| Example 11 | | | | | | | | | | | |
| Comparative | LTO | 30 | 60 | 10 | — | — | 6 | 13% | 19% | 78% | 311 |
| Example 12 | | | | | | | | | | | |

Rechargeable lithium battery cells of Examples 1 to 21 using the lithium titanium oxide negative active material, infrequently showed thickness increase rate after storing at 60° C., thus confirming the battery may be stably used without deforming the exterior shape and having excellent output characteristics since IR (potential difference) increase is reduced due to the thickness increase being less pronounced. In contrast, it is confirmed that rechargeable lithium battery cells of Comparative Examples 1 to 5 using a graphite negative active material showed significant IR (potential difference) increase; and rechargeable lithium battery cells of Comparative Examples 6 to 12 using the lithium titanium oxide negative active material showed significant IR (potential difference) increase and remarkably deteriorated cycle-life characteristics.

While the present embodiments have been described in connection with what is presently considered to be practical exemplary embodiments, it is to be understood that the invention is not limited to the disclosed embodiments and is intended to cover various modifications and equivalent arrangements included within the spirit and scope of the appended claims. Therefore, the aforementioned embodiments should be understood to be exemplary but not limiting this disclosure in any way.

What is claimed is:

1. A rechargeable lithium battery, comprising:
a negative electrode including a negative active material including lithium titanium-based oxide;
a positive electrode including a positive active material being capable of intercalating and deintercalating lithium; and
an electrolyte,
wherein the electrolyte comprises about 50 wt % to about 90 wt % of a sum of ethylene carbonate and γ-butyrolactone and about 10 to about 50 wt % of a component selected from the group consisting of propylene carbonate, ethylene acetate, and ethylene propionate, or combinations thereof.

2. The rechargeable lithium battery of claim 1, wherein the component is a combination of ethylene acetate and ethylene propionate.

3. The rechargeable lithium battery of claim 1, wherein the electrolyte further comprises one selected from the group consisting of dimethyl carbonate, diethyl carbonate, dipropyl carbonate, methylpropyl carbonate, ethylmethyl carbonate, ethylpropyl carbonate, 1,2-butylene carbonate, 2,3-butylene carbonate, 1,2-pentylene carbonate, 2,3-pentylene carbonate, and a combination thereof.

4. The rechargeable lithium battery of claim 1, wherein the electrolyte further comprises a compound represented by the following Chemical Formula 1: 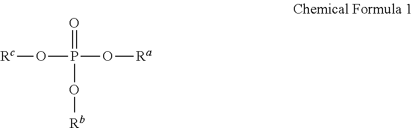
wherein, R^{a}, R^{b}, R^{c} are the same or independently selected from C1 to C4 linear or branched alkyl.

5. The rechargeable lithium battery of claim 4, wherein the electrolyte comprises the compound represented by the above Chemical Formula 1 in an amount of about 0.5 wt % to about 5 wt %.

6. The rechargeable lithium battery of claim 1, wherein the lithium titanium-based oxide is represented by the following Chemical Formula 3:
Li_{4-x-y}M_{y}Ti_{5+x-z}M′_{z}O₁₂ Chemical Formula 3
wherein, y is a value ranging from 0 to 1, z is a value ranging from 0 to 1,
M is La, Tb, Gd, Ce, Pr, Nd, Sm, Ba, Sr, Ca, Mg, or a combination thereof, and
M′ is V, Cr, Nb, Fe, Ni, Co, Mn, W, Al, Ga, Cu, Mo, P (phosphorus), or a combination thereof.

7. The rechargeable lithium battery of claim 1, wherein the lithium titanium-based oxide is at least one component selected from the group consisting of Li_{3.9}Mg_{0.1}Ti₅O₁₂, Li₄Ti_{4.8}V_{0.2}O₁₂, Li₄Ti_{4.8}Nb_{0.2}O₁₂, Li₄Ti_{4.8}Mo_{0.2}O₁₂, and Li₄Ti_{4.8}P_{0.2}O₁₂.

8. The rechargeable lithium battery of claim 1, wherein the lithium titanium-based oxide is represented by the following Chemical Formula 4:
Li₄₋ₓTi₅₊ₓO₁₂ Chemical Formula 4
wherein, x is a value ranging from 0 to 1.

9. The rechargeable lithium battery of claim 1, wherein the lithium titanium-based oxide is Li₄Ti₅O₁₂.

10. The rechargeable lithium battery of claim 1, wherein the electrolyte solution further comprises at least one lithium salt selected from the group consisting of LiPF₆, LiBF₄, LiSbF₆, LiAsF₆, LiC₄F₉SO₃, LiClO₄, LiAlO₂, LiAlCl₄, LiN(SO₂CₓF₂ₓ₊₁)(SO₂C_{y}F_{2y+1}SO₂) (wherein, x and y are natural numbers of 1 to 20, respectively), LiCl, LiI, LiB(C₂O₄)₂ (lithium bis(oxalato) borate), or a combination thereof.

11. The rechargeable lithium battery of claim 1, wherein the lithium salt is included in a concentration ranging from about 0.1 M to about 2.0 M.

12. The rechargeable lithium battery of claim 1, wherein the positive active material is LiₐA_{1-b}R_{b}L₂ (0.90≦a≦1.8 and 0≦b≦0.5);
LiₐE_{1-b}R_{b}O_{2-c}L_{c} (0.90≦a≦1.8, 0≦b≦0.5 and 0≦c≦0.05);
LiE_{2-b}R_{b}O_{4-c}L_{c} (0≦b≦0.5, 0≦c≦0.05);
LiₐNi_{1-b-c}Co_{b}R_{c}L_{α} (0.90≦a≦1.8, 0≦b≦0.5, 0≦c≦0.05 and 0<α≦2);
LiₐNi_{1-b-c}Co_{b}R_{c}O_{2-α}Z_{α} (0.90≦a≦1.8, 0≦b<0.5, 0≦c≦0.05 and 0<α<2);
LiₐNi_{1-b-c}Co_{b}R_{c}O_{2-α}Z₂ (0.90≦a≦1.8, 0≦b<0.5, 0≦c≦0.05 and 0<α<2);
LiₐNi_{1-b-c}Mn_{b}R_{c}L_{α} (0.90≦a≦1.8, 0≦b≦0.5, 0≦c≦0.05 and 0<α≦2);
LiₐNi_{1-b-c}Mn_{b}R_{c}O_{2-α}Z_{α} (0.90≦a ≦1.8, 0≦b ≦0.5, 0≦c≦0.05 and 0<α<2);
LiₐNi_{1-b-c}Mn_{b}R_{c}O_{2-α}Z₂ (0.90≦a≦1.8, 0≦b≦0.5, 0≦c≦0.05 and 0<α<2);
LiₐNi_{b}E_{c}G_{d}O₂ (0.90≦a≦1.8, 0≦b≦0.9, 0≦c≦0.5 and 0.001≦d≦0.1);
LiₐNi_{b}Co_{c}Mn_{d}GₑO₂ (0.90≦a≦1.8, 0≦b≦0.9, 0≦c≦0.5, 0≦d≦0.5 and 0.001≦e≦0.1);
LiₐNiG_{b}O₂ (0.90≦a≦1.8 and 0.001≦b≦0.1); LiₐCoG_{b}O₂ (0.90≦a≦1.8 and 0.001≦b≦0.1; LiₐMnG_{b}O₂ (0.90≦a≦1.8 and 0.001≦b≦0.1),
LiₐMnG_{b}O₄ (0.90≦a≦1.8 and 0.001≦b≦0.1);
QO₂; QS₂; LiQS₂; V₂O₅; LiV₂O₅; LiTO₂; LiNiVO₄;
Li_{(3-f)}Fe₂(PO₄)₃ (0≦f≦2); LiFePO₄, or a combination thereof.
wherein A is Ni, Co, Mn, or a combination thereof; R is Al, Ni, Co, Mn, Cr, Fe, Mg, Sr, V, a rare earth element, or a combination thereof; L is O (oxygen), F (fluorine), S (sulfur), P (phosphorus), or a combination thereof; E is Co, Mn, or a combination thereof; Z is F (fluorine), S (sulfur), P (phosphorus), or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof;
and J is V, Cr, Mn, Co, Ni, Cu, or a combination thereof.

13. The rechargeable lithium battery of claim 12,
wherein:
the positive active material is LiₐA_{1-b}R_{b}L₂ (0.90≦a≦1.8 and 0≦b≦0.5);
A is Ni, Co, Mn;
R is Al, Ni, Co, Mn, Cr, Fe, Mg, Sr, V; and
L is O (oxygen), F (fluorine), S (sulfur), P (phosphorus).

14. The rechargeable lithium battery of claim 13, wherein:
the positive active material is LiₐA_{1-b}R_{b}L₂ (0.90≦a≦1.8and 0≦b≦0.5);
A is Co; and
L is O (oxygen).

15. The rechargeable lithium battery of claim 14, wherein the positive active material is LiCoO₂.

16. The rechargeable lithium battery of claim 1, wherein the electrolyte comprises about 20 wt % or about 30 wt % of ethylene carbonate.

17. The rechargeable lithium battery of claim 16, wherein the electrolyte comprises about 20 wt %, about 30 wt %, about 40 wt %, or about 50 wt % of γ-butyrolactone.

18. The rechargeable lithium battery of claim 17, wherein the electrolyte comprises about 20 wt %, about 30 wt %, or about 40 wt % of γ-butyrolactone.
